(19) United States
(12) Patent Application Publication
(10) Pub. No.: US 2012/0191542 A1
(43) Pub. Date: Jul. 26, 2012

(54) Method, Apparatuses and Service for Searching

(75) Inventor: Mikko Nurmi, Tampere (FI)

(73) Assignee: NOKIA CORPORATION, Espoo (FI)

(21) Appl. No.: 13/380,872

(22) PCT Filed: Jan. 24, 2009
(86) PCT No.: PCT/FI09/50562

§ 371 Date: Apr. 5, 2012

(51) Int. Cl. G06Q 30/02; G06F 17/30

(52) U.S. Cl. 705/14.54; 707/769; 707/E17.005

(57) ABSTRACT

A method, devices, computer program products and systems for searching information are disclosed, where a search criterion based on input by a user and search criterion based on information on user attention are used in forming search results. The attention information is formed by gaze tracking or by following the user attention in another way, e.g. by EEG measurements.

### FIELD OF THE INVENTION

The present invention relates to searching data using search criteria from a user, and especially to improving the search results using auxiliary information related to the data.

### BACKGROUND

The amount of data at the reach of ordinary people today is massive. Computers, mobile communication devices and other electronic devices like music and video players have storage capacities reaching hundreds of gigabytes at best. Such storage space is large enough to store hundreds of thousands of files—on a single device. To go even further, data networks and especially the internet bring the storage capacities of hundreds of millions of computers at the reach of every single user who is able to access this network. And access is simple nowadays; it suffices to have an affordable mobile phone to connect to the internet. In fact, connecting to the internet through a phone, not a computer, may well become the prominent way of reaching the internet in many countries.

Very early people have realized that there is a great need for locating the right data among the vast mass of files on a computer or in the network, and programs have been developed for this purpose. Naturally, the problem of finding data in the internet has spawned many solutions called search engines. These internet search engines operate so that they index the content on the internet with the help of so-called crawlers that inspect and index the contents of individual web pages accessible on web servers and reachable by the users of internet.

In all of the above solutions, a typical way of finding data works so that the user inputs search criteria, typically keywords, presses a button to submit the search request, and the server performs the search and returns a list of hyperlinks to the pages that contain the search results. The user is then easily able to follow these hyperlinks with the click of a mouse and to see whether the page contains information of interest. Of course, with the vast amount of data on the internet, the number of relevant pages returned by a single search can be perplexing: for example, carrying out a search with the keywords “search engines” on Google results in more than 57 million pages that are somehow relevant. Trying to narrow this down to find search engines that relate to Santa Claus in Lapland, Finland, the search returns only one web site with relevant information. This is often the case in searching for data: the results are either far too many, or then too few to offer choice and to make it more likely for the user to find interesting, new or relevant information.

There is, therefore, a need for a solution that improves the existing search methods so that the user can more easily find relevant and interesting information.

### Some Example Embodiments

Now there has been invented an improved method and technical equipment implementing the method, by which the above problems are alleviated. Various aspects of the invention include a method, an apparatus, a server, a client and a computer readable medium comprising a computer program stored therein, which are characterized by what is stated in the independent claims. Various embodiments of the invention are disclosed in the dependent claims.

According to a first aspect, there is provided a method for searching information by an apparatus, comprising electronically generating a search criterion based on input by a user, using the search criterion for electronically carrying out a search from a data set to electronically determine search results, electronically generating a search criterion based on information on user attention, and using the search criterion in electronically determining search results.

According to an embodiment, search results are produced to the user, and information of the user attention is indicated in connection with the search results to the user.

According to an embodiment, information on user attention is formed by gaze tracking. Gaze tracking can be performed using eye orientation detection, face orientation detection or head orientation detection.

According to an embodiment, information on user attention is formed by measuring a physiological signal from a user. The physiological signal can be an electroencephalograph, a magnetoencephalograph, a functional magnetic resonance image, an electrocardiograph, a magnetocardiograph or an electromyograph or any other source of such signal.

According to an embodiment, input by a user is received by using a keyboard, a mouse, a stylus, a speech detection system or an optical sensor such as a camera or a touch of finger, voice input, using mind controlling based on information detected by analysing brain waves, or any other sensors like haptic sensors based on optics or impedance measurements, or generally any other input mechanism.

According to an embodiment, information containing said user input is received over a data connection, and a search criterion is formed using said information containing said user input.

According to an embodiment, information on user attention is received over a data connection, and a search criterion is formed using information on user attention.

According to an embodiment, information on user attention is formed by combining attention information associated with at least two users.

According to an embodiment, the search relates to data containing textual information such as word processing information, presentation information or spreadsheet information, data containing media information such as image information, video information, audio information, music information, metadata information, or information about associations between information items.

According to an embodiment, advertisements are formed to be displayed to the user, where the advertisements are relevant to at least one of said search criteria or the search results.

According to a second aspect, there is provided an apparatus comprising at least one processor, memory including computer program code, the memory and the computer program code configured to, with the at least one processor, cause the apparatus to perform at least the following: forming a search criterion based on input by a user, using said search criterion for carrying out a search from a data set to form search results, forming a search criterion based on information on user attention, and using said search criterion in forming said search results.

According to an embodiment, the apparatus comprises computer program code that is configured to, with the at least one processor, cause the apparatus to perform at least the following: producing search results to the user, and indicating information of user attention in connection with said search results to the user.

According to an embodiment, the apparatus comprises computer program code that is configured to, with the at least one processor, cause the apparatus to form information on user attention by gaze tracking. Gaze tracking can be performed using eye orientation detection, face orientation detection or head orientation detection.

According to an embodiment, the apparatus comprises computer program code that is configured to, with the at least one processor, cause the apparatus to form information on user attention by measuring a physiological signal from a user. The physiological signal can be an electroencephalograph, a magnetoencephalograph, a functional magnetic resonance image, an electrocardiograph, a magnetocardiograph or an electromyograph.

According to an embodiment, the apparatus comprises computer program code that is configured to, with the at least one processor, cause the apparatus to receive said input by a user using a keyboard, a mouse, a stylus, a speech detection system or an optical sensor such as a camera, touch input, voice input, or brain wave based input, or any other sensors like haptic sensors based on optics or impedance measurements, or generally any other input mechanism.

According to an embodiment, the apparatus comprises computer program code that is configured to, with the at least one processor, cause the apparatus to perform at least the following: receiving information containing user input over a data connection, and forming search criterion using information containing user input.

According to an embodiment, the apparatus comprises computer program code configured to, with the at least one processor, cause the apparatus to perform at least the following: receiving information on user attention over a data connection, and forming search criterion using said information on user attention.

According to an embodiment, the apparatus comprises computer program code configured to, with the at least one processor, cause the apparatus to form said information on user attention by combining attention information associated with at least two users.

According to an embodiment, the search relates to data containing textual information such as word processing information, presentation information or spreadsheet information, or media information such as image information, video information, audio information,music information, metadata information, or information about associations between information items.

According to an embodiment, the apparatus further comprises a sensor for attention tracking, user interface circuitry for receiving user input, user interface software configured to facilitate user control of at least some functions of the mobile phone though use of a display and configured to respond to user inputs, and a display and display circuitry configured to display at least a portion of a user interface of the mobile phone, the display and display circuitry configured to facilitate user control of at least some functions of the mobile phone, and computer program code configured to, with the at least one processor, cause the apparatus to track the attention of the user to form information on user attention, receive user input via the user interface circuitry to form the first search criterion, and produce the search results via the display to the user.

According to an embodiment, the apparatus comprises computer program code configured to, with the at least one processor, cause the apparatus to form advertisements to be displayed to the user, said advertisements being relevant to at least one of said search criteria and said search results.

According to a third aspect, there is provided a computer program product stored on a computer readable medium and executable in a data processing device, wherein the computer program product comprises a computer program code section for forming a search criterion based on input by a user, a computer program code section for using the search criterion for carrying out a search from a first data set to form search results, a computer program code section for forming a search criterion based on information on user attention, and a computer program code section for using the search criterion in forming said search results.

According to an embodiment, the computer program product comprises a computer program code section for receiving information containing user input over a data connection, a computer program code section for forming the search criterion using information containing user input, a computer program code section for receiving information on user attention over a data connection, and a computer program code section for forming a search criterion using the information on user attention.

According to a fourth aspect there is provided an apparatus comprising means for forming a first search criterion based on input by a user, means for using said first search criterion for carrying out a search from a first data set to form search results, means for forming a second search criterion based on information on user attention, and means for using said second search criterion in forming said search results.

### DESCRIPTION OF THE DRAWINGS

In the following, various embodiments of the invention will be described in more detail with reference to the appended drawings, in which

FIG. 1 shows a conventional method for carrying out a search;

FIG. 2a shows a setup of devices, servers and networks with different embodiments of the invention;

FIG. 2b shows functional elements of devices in FIG. 2a;

FIG. 3 shows a method according to an embodiment of the invention for carrying out a search;

FIG. 4 shows some possible ways of carrying out gaze tracking;

FIG. 5a shows some possible ways of recording user attention based on a physiological signal from the human brain such as an electroencephalogram (EEG) or a magnetoencephalogram (MEG);

FIG. 5b shows some possible ways of recording user attention based on a physiological signal from the human body such as electrocardiograph (ECG), magnetocardiograhic (MCG) and electromyographic (EMG).

FIG. 6 shows a web page where information of user attention has been associated with the elements of the web page;

FIG. 7 shows different ways of indicating the search results to the user when information on user attention has been used in the search;

FIG. 8 shows a way of indicating the search results on a text document where information on user attention has been used in the search;

FIG. 9 shows a way of indicating the search results on a video document where information on user attention has been used in the search;

FIG. 10 shows a way of indicating the search results from pictures where information on user attention has been used in the search;

### DETAILED DESCRIPTION OF SOME EXAMPLE EMBODIMENTS

In the following, several embodiments of the invention will be described in the context of an apparatus comprising hardware elements and software code executable on a processor that enables the apparatus to carry out a search of data, as well as a network element comprising hardware elements and software code executable on a processor that enables the network element to carry out a search of data, as well as a network connecting two or more of these devices so that they can communicate and access data offered by the different devices. It is to be noted, however, that the invention is not limited to operating on a single device. In fact, the different embodiments have applications widely in any environment where improved search functionalities are needed, for example in an environment where data and/or computer programs are distributed among different devices.

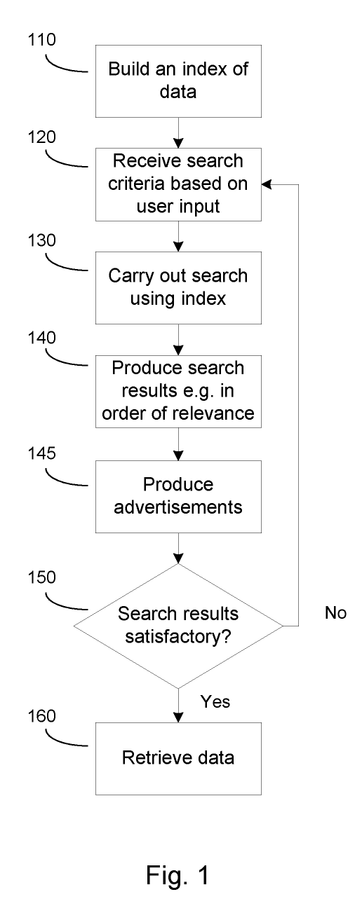

FIG. 1 shows a method for performing a search among target data based on criteria received from a user of a device that takes part in the search. As explained in the background of the invention, the internet and many computing devices of today have a vast storage capacity. Therefore, it may not be possible to access all the information at once when a search is requested. For example, if the user wants to find out most relevant pages that contain information about “search engines”, it is not practical to sequentially access all documents in the internet to find the answer. To make the search feasible or faster, an index 110 may be built. This is done so that prior to the search, pages on the internet are visited by a so-called crawler that classifies and indexes the words and other information like images that reside on the pages. The index that has been built by such crawlers can then be employed in the search without accessing the data of the internet pages directly at the time of the search. The same principle of building an index can be used in searching for information in other contexts, such as finding certain text documents on a computer, finding certain photographs on a mobile communication device, or finding files or metadata from an internet service site such as OVI®. On the other hand, with the development of faster processors, memories and communication apparatuses, carrying out the search entirely or in part directly from the data itself may be possible.

To perform the search, the user needs to define the scope of the search, that is, search criteria based on user input need to be received in step 120. This receiving of the search criteria can happen in various ways. On a device that the user is using for giving the search criteria, the criteria can be received in step 120 via a keyboard, a mouse, a stylus, finger input on a touch sensitive screen or area, a speech detection system or an optical sensor such as a camera using mind controlling based on information detected by analysing brain waves, or any other sensors like haptic sensors based on optics or impedance measurements, or generally any other input mechanism, or any other means that can be used for receiving input from a user to a computer (any human interface device). This input can be in textual form, such as keywords, or it can be in the form of a choice by a mouse click, or another type of indication about which data it is the user wishes to find. The user may also indicate that the data to be searched is not the whole set of data, but the search results of an earlier search or a combination of earlier searches. If the search is carried out in a network server or by a computer that is not directly accessed by the user, the search criteria may be received in step 120 from a network interface such as an internet connection, a mobile communication network connection or a local connectivity connection.

When the search criteria have been received, the search is carried out in step 130, possibly using the index built in step 110 for the whole search or for a part of the search. After performing the search, the search results are produced visually or in audio or tactile format to the user in step 140. This can happen by the means of a list that shows the results in an order according to the relevance of the results. Alternatively, the results can be shown in pictorial format, or read by means of speech synthesis to the user, or produced in tactile format.

In connection with the search results, advertisements can be produced to the user in step 145. The producing of advertisements is optional. This can happen so that the advertisements are related to the search criteria received in step 120. The advertisements need not be produced by the same device that performs the search in step 130, but they can be. Alternatively, the advertisements may be retrieved from a different device. To be able to produce the relevant advertisements to the user, the search criteria from step 120 are used at least partly in determining the advertisements, or alternatively or together with the search criteria, the search results from step 130 are used at least partly in determining the advertisements. If the user determines that the search results are satisfactory in step 150, the found data can be received and produced to the user in step 160, e.g. by opening and showing the document or a web page. On the other hand, if the user determines in step 150 that the search results are not satisfactory, new or altered search criteria can be received from the user, and the method continues from step 120.

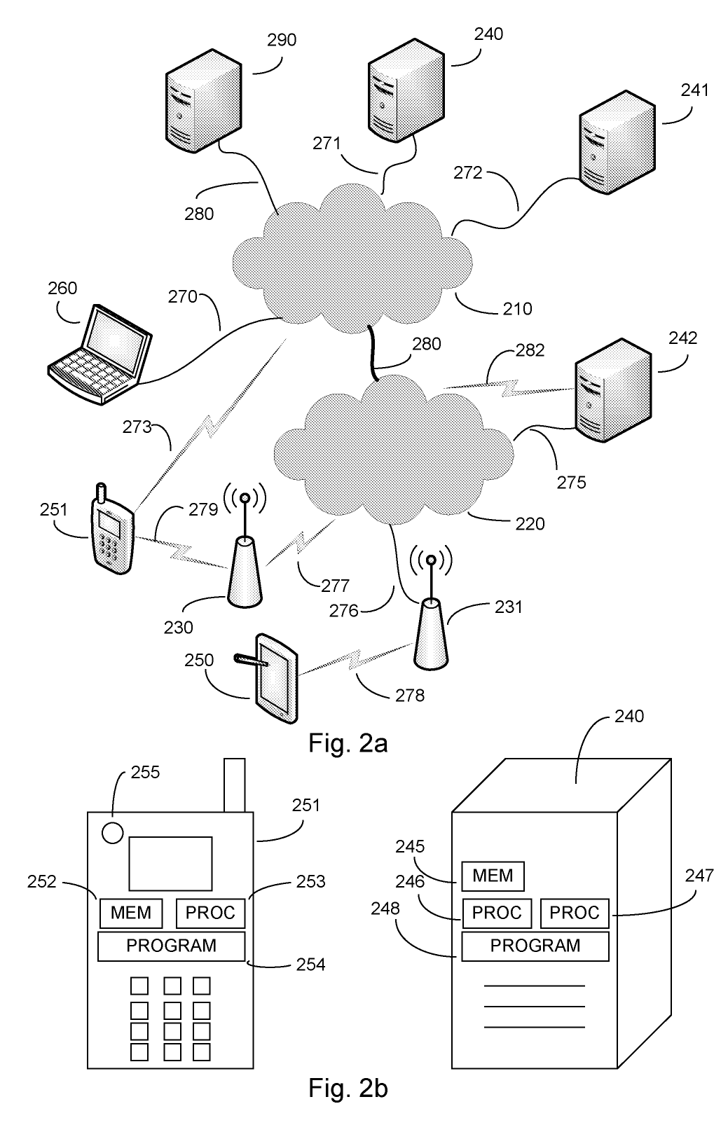

FIG. 2a displays a setup of devices, servers and networks that contain elements for performing a search in data residing on one or more devices. The different devices are connected via a fixed network 210 such as the internet or a local area network, or a mobile communication network 220 such as the Global System for Mobile communications (GSM) network, 3^{rd} Generation (3G) network, 3.5^{th} Generation (3.5G) network, 4^{th} Generation (4G) network, Wireless Local Area Network (WLAN), Bluetooth, or another contemporary and future networks. The different networks are connected to each other by means of a communication interface 280. The networks comprise network elements such as routers and switches to handle data (not shown), and communication interfaces such as the base stations 230 and 231 in order for providing access for the different devices to the network, and the base stations are themselves connected to the mobile network via a fixed connection 276 or a wireless connection 277.

There are a number of servers connected to the network, and here are shown a server 240 for performing a search and connected to the fixed network 210, a server 241 for producing advertisements and connected to either the fixed network 210 or the mobile network 220 and a server 242 for performing a search and connected to the mobile network 220. There are also a large number of computing devices 290 connected to the networks 210 and/or 220 that are there for storing data and providing access to the data via e.g. a web server interface or data storage interface or such. These devices are e.g. the computers 290 that make up the internet with the communication elements residing in 210.

There are also a large number of end-user devices such as mobile phones and smartphones 251, internet access devices (internet tablets) 250 and personal computers 260 of various sizes and formats. These devices 250, 251 and 260 can also be made of multiple parts. The various devices are connected to the networks 210 and 220 via communication connections such as a fixed connection 270, 271, 272 and 280 to the internet, a wireless connection 273 to the internet, a fixed connection 275 to the mobile network, and a wireless connection 278, 279 and 282 to the mobile network. The connections 271-282 are implemented by means of communication interfaces at the respective ends of the communication connection.

As shown in FIG. 2b, the search server 240 contains memory 245, one or more processors 246, 247, and computer program code 248 residing in the memory 245 for implementing the search functionality. The different servers 241, 242, 290 contain at least these same elements for employing functionality relevant to each server. Similarly, the end-user device 251 contains memory 252, at least one processor 253, and computer program code 254 residing in the memory 252 for implementing the search functionality. The end-user device may also have at least one sensor e.g. camera 255 enabling the tracking of the user. The different end-user devices 251, 260 contain at least these same elements for employing functionality relevant to each device.

It needs to be understood that different embodiments allow different parts to be carried out in different elements. For example, the search may be carried out entirely in one user device like 250, 251 or 260, or the search may be entirely carried out in one server device 240, 241, 242 or 290, or the search may be carried out across multiple user devices 250, 251, 260 or across multiple network devices 240, 241, 242, 290, or across user devices 250, 251, 260 and network devices 240, 241, 242, 290. The search can be implemented as a software component residing on one device or distributed across several devices, as mentioned above. The search may also be a service where the user accesses the search through an interface e.g. using the browser.

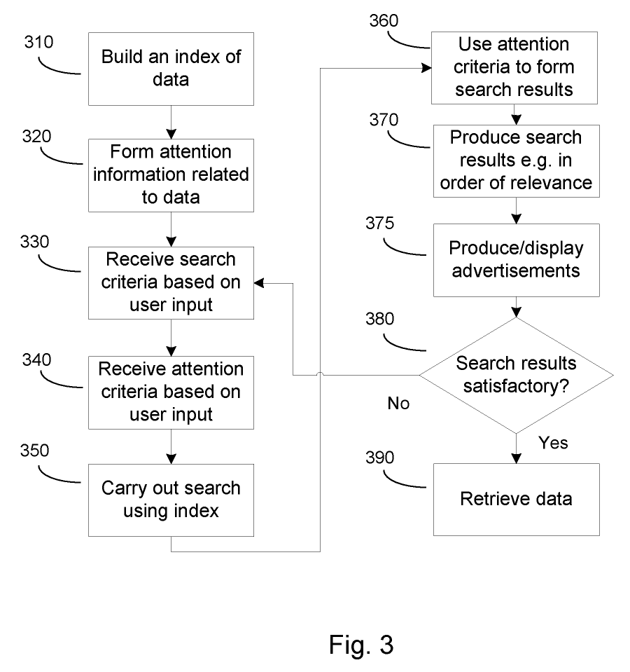

FIG. 3 shows a method for performing a search among target data based on criteria received from a user of a device that takes part in the search as well as information based on user attention. As explained in the context of FIG. 1, to make the search feasible or faster, an index 310 may be used. The index again consists of classification and indexing information of the content in the internet, in a specific web service like OVI® or on the device, or some or all of these together.

In addition to building an index, attention information related to data among which the search is carried out is collected in 320. In one embodiment, to form the attention information, the gaze of the end user is followed and it is detected which content data the user is looking at and for how long. This information is then stored to be used later on to help the user search either content that is familiar to him or content that is not familiar to the user, or content that is slightly familiar to the user or any search between the two extremes of very familiar data and unknown data. Content data is considered to be more familiar to the user if he has looked at the material for longer period of time. Shortly viewed material can be defined as slightly familiar. Content that user hasn't looked at can be defined as unfamiliar or unknown data.

One other possibility to define content familiarity or the attention information is related to electroencephalographic (EEG) signals. Electroencephalography (EEG) is the recording of electric potential on the scalp produced by the firing of neurons within the brain. Currently, EEG information is used in diagnostics of different brain disorders etc., but recently there has been many examples of using EEG information for analyzing brain activity in different situations during normal activity of the person. Derivatives of the EEG technique are used in cognitive science, cognitive psychology, and psychophysiological research. In the present context, EEG information can be used to define how intensively user is focusing on reading and viewing content that the user is currently looking at or listening to. Sometimes user pays attention to the text, document, images, music or video in a very focused manner but sometimes he might just be paying attention cursorily. This attention information may be stored at the user device, at another device, at a network server or in connection with a service e.g. a file storage service, a picture service, a social networking service, a music service or a location service.

It is also possible to aggregate the attention data of several users for example in the context of such services to form aggregate attention data. The forming of the aggregate attention information can be done by simply combining all individual data, or the data can be formed by performing logical operations between the data. For example, the aggregate attention data can be formed by combining the attention information of one group of users, but requiring that the files that are familiar to this one group must not be familiar to another group of users thereby applying a negation to the attention data of the second group of users before combining it with the attention data of the first group of users. The attention data can also be time-dependent, e.g. older attention information may receive a smaller weight to take into account that the user may be forgetting information he has seen a long time go. The attention data can be binary (familiar/unfamiliar), it can contain levels (very familiar/familiar/somewhat familiar/unfamiliar) or it may have a range of values, or even be a fuzzy variable. Further, when attention information has been acquired for a data item, it is also possible to assign attention information to data items that are similar by some criteria. For example, if a single e-mail in an chain of e-mails is assigned an attention information of “familiar”, the rest of the e-mails in the same chain can be assigned an attention information “slightly familiar”.

To perform the search, the user needs to define the scope of the search, that is, search criteria based on user input need to be received in step 330. This receiving of the search criteria can happen in various ways. On a device that the user is using for giving the search criteria, the criteria can be received in step 330 via a keyboard, a mouse, a stylus, finger input on a touch sensitive screen or area a speech detection system or a camera, or any other means that can be used for receiving input from a user to a computer (any human interface device). This input can be in textual form, such as keywords, or it can be in the form of a choice by a mouse click, or another type of indication about which data it is the user wishes to find.

The user may also indicate that the data to be searched is not the whole set of data, but the search results of an earlier search or a combination of earlier searches. If the search is carried out in a network server or by a computer that is not directly accessed by the user, the search criteria may be received in step 330 from a network interface such as an internet connection, a mobile communication network connection or a local connectivity connection. In other words, a certain single device forms the information on what the user wants to search for, and in some cases it happens by directly receiving user input from the user of the same device, and in some other cases the search criteria are formed at the device by receiving from a communication interface information of user input taken at another device, and then forming the search criteria based on this received information. It is also possible that the application resides on multiple devices and only parts are carried out at each device.

In phase 340, attention criteria are formed to be able to take into account attention information in the search. The attention criteria may be received originally from the user, e.g. in textual format by the user typing “familiarity=known” as an input to the search, or by the user selecting a level of attention/familiarity using radio buttons or a slide, and possibly ranging from “known” to “unknown” with “slightly known” as an option in between. The attention criteria may also be received simply by holding it as a default, e.g. that only unknown data is searched. As before, in the case of a user device, the attention criteria may be received as input from the user, while for a server device or a service, the attention criteria are received from a communication interface to the server.

When the search criteria and attention criteria have been received, the search is carried out in step 350, possibly using the index built in step 310 for the whole search or for part of the search. The attention criteria can be used in phase 350 together with the search criteria in performing the search. In such an embodiment, the attention criteria and search criteria are somehow combined in order to arrange the search results in an order of relevance. This can be achieved by assigning weights to search criteria and attention criteria—these weights can even be assigned by the user or by a system administrator. Alternatively, the search results may be given relevance points by the search criteria and attention points by the attention criteria, and these points are then combined. In one embodiment, the attention criteria are applied to the search results in phase 360 so that the search results matching the attention criteria are shown first. It is also possible to apply the attention criteria first and then perform the search among data that matches the attention criteria.

After performing the search, the search results are produced visually or in audio or tactile format, or any combination of these formats to the user in step 370. This can happen by the means of a list that shows the results in an order according to the relevance of the results. Alternatively, the results can be shown in pictorial format, or read by means of speech synthesis to the user, or produced in tactile format. In association with showing the search results, the attention information for the search results can also be shown for the different result items. Attention information can include, for example, number of earlier attention events, duration of earlier attention events, level of attention during attention events, portion of user attention events vs. attention events of other users.

In connection with the search results, advertisements can be produced to the user in step 375. The producing of advertisements is optional. This can happen so that the advertisements are related to the search criteria received in step 330. The advertisements need not be produced by the same device that performs the search in step 350, but they can be. Alternatively, the advertisements are retrieved from a different device. To be able to produce the relevant advertisements to the user, the search criteria from step 330 are used at least partly in determining the advertisements, or alternatively or together with the search criteria, the search results from step 350 are used at least partly in determining the advertisements.

Attention criteria from step 340 or attention information from step 320 can also be used in producing the advertisements. For example, advertisements shown in the context of search results can be produced so that they relate to information that is known to the user, but not to information that is not known to the user. The display of advertisements can happen in the following way on a web page. The web page contains two pieces of information. One piece of information, e.g. a certain image, is familiar to the user and another piece of information is not. The system will then show advertisements that are linked to the familiar piece of information, that is, the image. Alternatively, advertisements shown in the context of search results can be produced so that they relate to information that is not known to the user, but not to information that is known to the user. Yet alternatively, advertisements shown in the context of search results can be produced so that they relate to information that is slightly known to the user. The advertisements can also be shown in the context of retrieving data, e.g. on a web page or in an e-mail, and again the attention information of data can be used to select advertisements that are produced to the user.

The attention level of the user to the advertisements can also be detected. The detection of level of attention can be augmented with information on user's reaction to the advertisement, e.g. the detection of feelings such as excitement. This advertisement attention level can then be used in various ways. For example, if advertisements are presented to the user in different formats, and attention level related to the different formats is detected, the system can offer advertisements in the format that results in the highest attention level based on the detection. In addition, the advertisers can be billed based on the sum of attention levels of all users viewing certain advertisement, or based on the attention levels of a sample of a few viewers of the advertisement. If the user determines that the search results are satisfactory in step 380, the found data can be received and produced to the user in step 390, e.g. by opening and showing the document or a web page. At this point, the attention information can be used further to e.g. indicate those areas in the document or retrieved data that the user has paid attention to. If the user determines in step 380 that the search results are not satisfactory, new or altered search criteria can be received from the user, and the method continues from step 330.

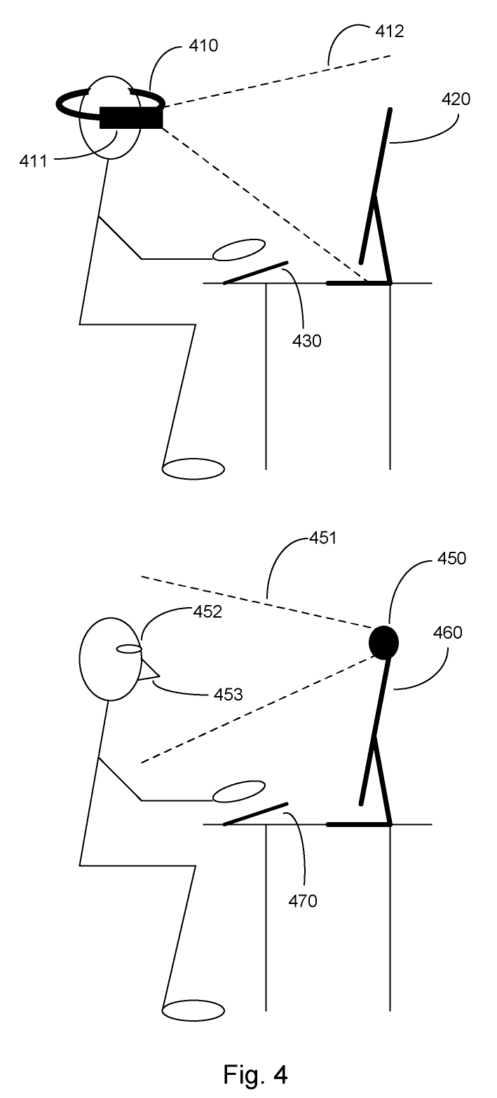

FIG. 4 displays ways of performing gaze tracking in order to form attention information according to various embodiments of the invention. In one embodiment, the user may wear a device 410 attached to the head of the user, to the shoulders of the user or to another body part or as part of the clothing. The device 410 can be connected through wired electric or optical connection or via a wireless radio to the computer of the user or it can send the attention information to a network server. The device 410 comprises an element or a sensor 411 for determining the direction of attention such as a camera or a position and orientation determining device. The device 411 has a field of attention 412 that is defined by the orientation of the device. The field of attention may also be defined by the orientation of the user's eyes. The field of attention can be used to determine the point at which the user has targeted his attention at the display 420. The user gives input to the computer e.g. via the keyboard 430.

In another embodiment, the user's computer has a camera 450 attached to the display 460. The camera has a field of view 451 that is oriented so that it covers the user's face. The camera 450 is either connected to the computer of the user or it is a standalone gaze tracking device that can send attention information e.g. to a network server. The camera 450 or the computer to which the camera is connected has means for detecting the orientation of the user, e.g. by detecting the orientation of the eyes 452 or the nose 453. This can be achieved by face tracking software. The two embodiments for detecting the user's gaze can be used simultaneously or separately.

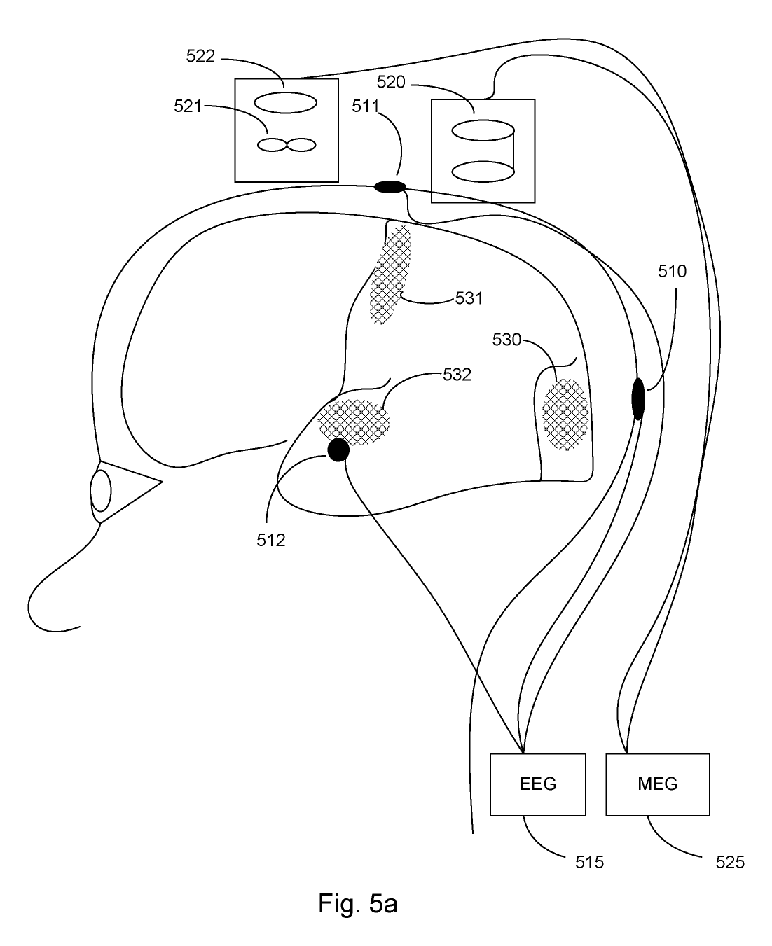

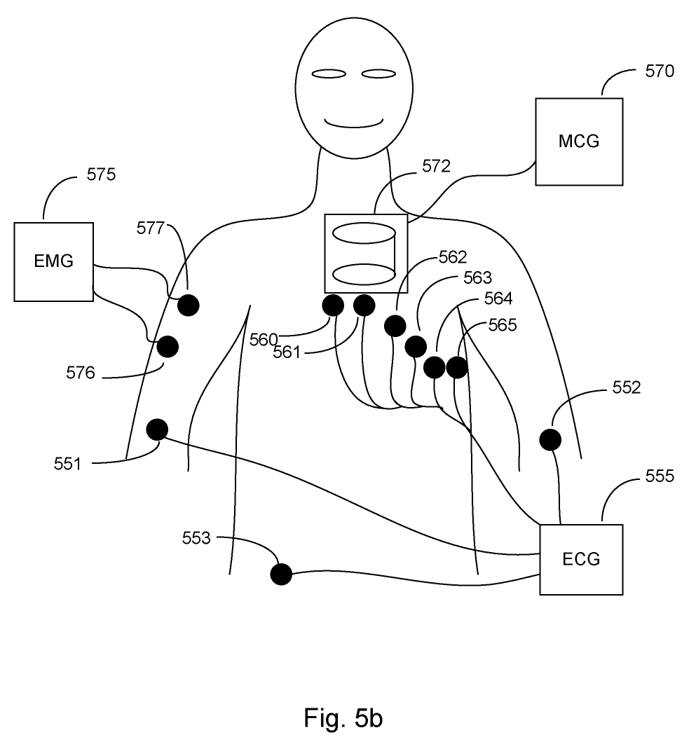

FIG. 5a displays a way of determining user attention information by recording a physiological signal from the user's brain. The recording of brain activity can happen in various ways. In electroencephalography (EEG) 515, the electric field caused by electrical activity in the brain, that is, the firing of neurons as a result of brain activity, is recorded with electrodes 510, 511 and 512 from the surface of the scalp. The electric potential signal picked up by the electrodes is led to the EEG amplifier that amplifies the microvolt-level signal and converts it into digital format for processing.

Correspondingly, in magnetoencephalography, the magnetic field caused by electrical activity in the brain is recorded with coils of different kinds: axial gradiometers 520, planar gradiometers 521 and magnetometers 522. The coils that are able to record such minuscule magnetic fields are typically superconducting, and employ a special device called a superconducting quantum interference device (SQUID) in a phase-locked loop to be able to amplify and record the signal in digital form in the MEG recording device 525. Yet further, brain activity can also be measured with the help of functional magnetic resonance imaging.

Different areas of the human brain are responsible of different information processing tasks. For example, there is an area responsible for visual processing 530, an area for processing somatosensory information 531 and an area for auditory processing 532. These areas reside on the cortex of the human brain, which is closest to the skull and contains several sulci so that the area of the cortex is significantly larger than the area of the skull. Recording signals from different locations of the brain thus reveals information on different information processing tasks of the brain. For example, it is possible to detect when a person receives a visual stimulus, i.e. sees a picture, from the visual cortex 530, and to detect when a person hears a sound from the auditory cortex 532.

The human brain also demonstrates to have different basic frequencies that can be measured with EEG and that are present at different times depending on what the person is doing. For example, alpha waves of 8-12 Hz appear when a person closes his eyes, and beta waves of 12-30 Hz are related to active concentration. In the present context, the fact that signals from different areas of the brain can be recorded to detect activity, and different signals from the brain carry different information makes it possible to envision that user attention information is picked up by means of EEG or MEG. For example, the level of alertness of the user may be converted to attention information of the user.

FIG. 5b displays a way of determining user attention information by recording a physiological signal from the user's body. The electrical activity of the heart causes an electric field in the human body, and the electric potential of this electric field can be picked up from the body surface with electrodes 551, 552, 553 and 560-565. Such recording is called an electrocardiograph (ECG). The signals from the electrodes are amplified and converted to digital format in the ECG recording device 555. Currently, such ECG recording devices can also be wearable, for example the devices that are used for monitoring the heart during sports.

The electrical activity of the human heart also causes a magnetic field that can be picked up by magnetocardiograhic (MCG) coil arrangements 572 and an MCG recording device 570. The electrical signals caused by working muscles can similarly be recorded with electrodes 576 and 577 and an electromyographic (EMG) recording system 575. These systems give information about the heartbeat frequency and the activation of the heart in many ways, the muscle activity and skin impedance. Such information, e.g. an elevated heartbeat frequency and skin impedance, can be used for forming user attention information. In addition to measuring signals with different sensors, physiological information can be detected by using a camera, for example by detecting frequency of blinking the eyes, detecting blushing of the skin or registering movement of the body.

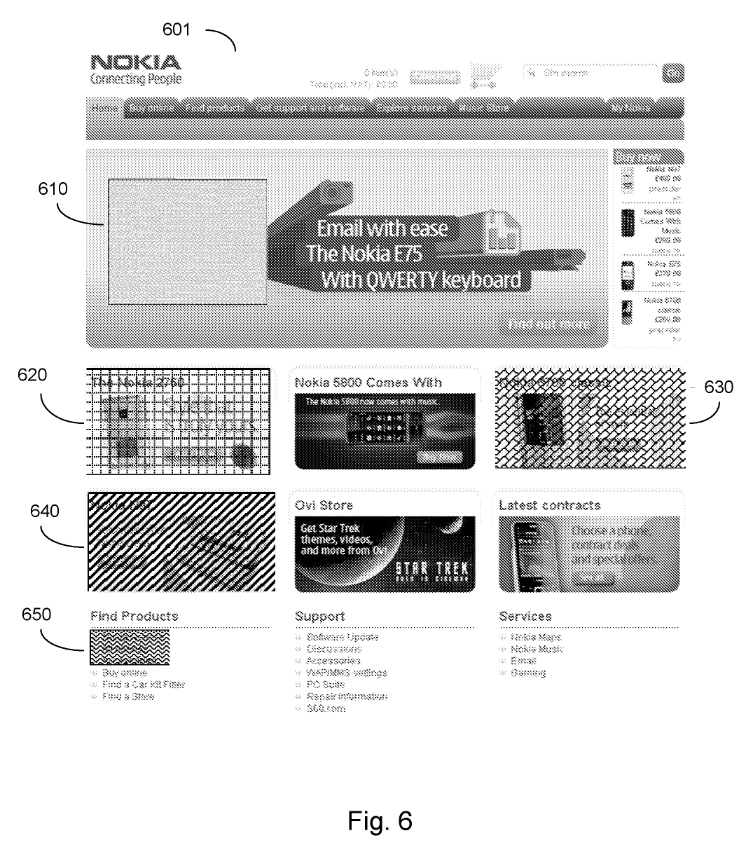

FIG. 6 displays an example of attention information detected from the user by way of gaze tracking or by measuring a physiological signal. The attention information is related to a web page 601 the user has been looking at on a browser. The user has spent a different time and potentially looked with different interest at the different elements on the web page, while some elements have not received attention at all. The user has looked for a long time at the Nokia N97 presentation 640, or he has looked at the Nokia N97 presentation 640 and physiological information indicates that the user has been excited to see such a new product. The user has paid some attention to the presentation 630 of the Nokia 9700 product and the general product information 650. The user has just cursorily looked at the presentation 620 of the Nokia 2760 product and the picture 610 of the Nokia E75 product in the e-mail presentation. The attention information is processed and stored in a database or attention index, for example so that the different elements are put in different categories as follows:

High Focus:
“Nokia N97” (picture and text)

Medium Focus:
“Nokia 9700 classic” (picture and text)
“Nokia Find Products” (text)

Low Focus:
“Nokia 2760” (picture and text)
“Nokia E75” (picture)

The attention information is stored to database which stores information about the content and the type of content (text, images etc.) user has been looking at and for how long. In one embodiment of this invention also EEG information is stored as such or in processed format. This information can be stored to see what was the focus level of the user when he was gazing particular part of a web page or any other content.

The search index and attention information can be collected for many different types of data, practically any type of digital content, for example text documents, advertisement content, web pages, presentation slides, spreadsheet documents, music files, audio recordings, pictures and videos, and any content in a network service, or even search results from a search, social events like phone calls, calendar events or reminders and chat discussions. For many types of data such as the web pages, e-mails, text documents, spreadsheets, presentations, audio and music, and video content, the attention data can indicate also what part of the file was looked at or listened to and for how long or how intensively. For example, in a text document, the paragraph or sentence can be stored for attention information if the user spent time looking at it, or a slide or worksheet area that the user was looking at can be indicated with high attention information. Further, for music and videos, social events like phone calls, calendar events or reminders, chat discussions, the feelings or attention level can be stored for attention information when the user is viewing the file or listening to music. For pictures, methods like face detection and positioning can be combined with the attention information e.g. so that “the user was looking at a picture of Anne for a long time and with high emotion”.

Similarly, the content from a web service, for example, attention information can be attached to a social networking service, e.g. so that “the user paid a lot of attention to messages, status updates and quizzes from Mike”, and such information can then later be used to e.g. offer more messages from Mike and his friends to be viewed by the user. Further, the attention value of a piece of information for a user can be associated with a certain device or a certain user interface. This makes it possible for the user to define advanced search criteria like searching for information that is familiar to the user via this device's user interface. In other words, in addition to storing attention level in general level, the attention level related to a data item is divided into two or more subareas, for example attention level via mobile device and attention level via laptop.

The attention data can also be collected for many users. The attention data can then be shared among users, for example so that friends allow each other to access their attention data. Attention data can also be shared freely among anyone, or it can be aggregated so that individual users are not recognized. The possibility to access the attention data of others allows a user to search for information that is familiar, slightly familiar or unfamiliar for another user or a group of users.

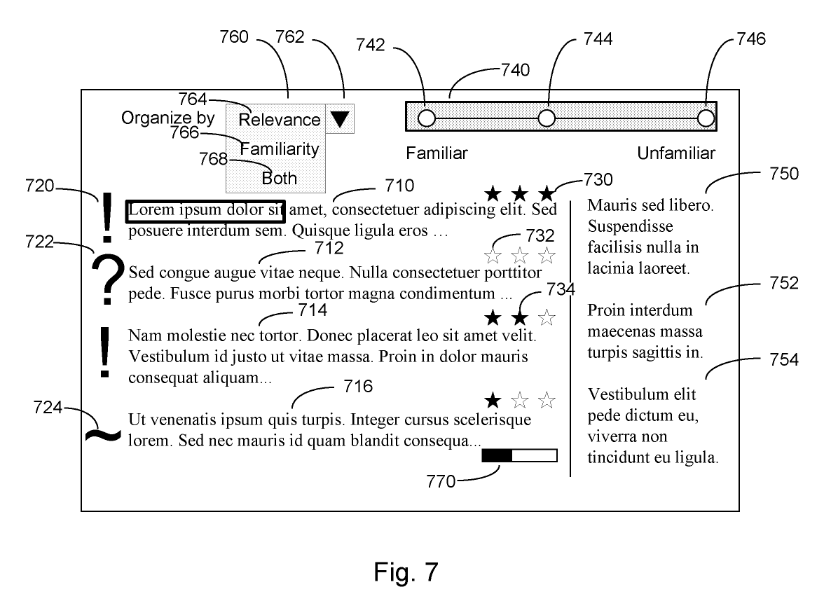

FIG. 7 shows an example of displaying search results to the user with associated attention information. The different items 710, 712, 714 and 716 found in the search are shown to the user in short format. It is also possible to show to the user only the part of the item that the user has previously paid attention to, i.e. for which the attention information indicates that the user knows the data. The interesting information on the basis of the attention criteria can also be highlighted in various ways, e.g. by colors, blinking, bolding or enlarging or drawing a box around the familiar information or underlining. Attention information for the item can also be indicated with an icon associated with the item, e.g. an exclamation mark 720 for familiar items, a question mark 722 for unfamiliar items and a tilde 724 for somewhat familiar items. The attention information for items can also be shown with e.g. discrete stars 730, 732, and 734, where more stars indicate a more familiar item or an item with more positive earlier experience and less stars indicate a less familiar item or an item with less positive earlier experience. The attention information for items may also be shown with an indicator having a continuous scale such as a scale bar 770 in horizontal, vertical or diagonal posture, a color scale indicator or a gray scale indicator where the color or shade of gray indicates level of familiarity, or any other indicator having a continuous scale. Combining the continuous and discrete scales may also indicate familiarity e.g. so that the stars in 730, 732 and 734 are partly filled with colour to indicate fractional levels of attention. For example, a figure of 2.5 may be indicated with two fully filled stars and one star filled in half.

The search result display can also have an indicator and a control for showing and giving the attention criteria that were used in the search. This can be achieved e.g. by a slide 740 for indicating what kind of items the user wishes to find (familiar 742 or unfamiliar 746 or slightly familiar 744). Selecting e.g. “slightly familiar” attention criteria 744 may lead to the search coming up with items that the user has once seen somewhere but could not remember where to find again. This is especially useful for searching for existing information. On the other hand, if the user wishes to find new data, he could select “unfamiliar” 746 as the attention criteria and thereby make sure that completely new information to him is found. As explained earlier, advertisements 750, 752 and 754 may optionally be displayed in connection with the search results. The advertisements may be found so that relevant ads to the search criteria are selected to be displayed, and the attention criteria can be used to further choose which advertisements are shown or in which order the advertisements are shown.

The search results may be shown in order of relevance based on the search criteria from the user. There may also be a possibility to choose from options in which the search results are shown as in 760. The different options may be selected by any input means, e.g. a drop-down menu as in 762, a radio button selection, a slide, a textual input, or by clicking the result list items or their header to organize according to relevance or by clicking the familiarity indicators or their header to organize according to relevance. It may be possible to organize the search results based on relevance as in 764, by familiarity as in 766 or by combination of the relevance and familiarity as in 768.

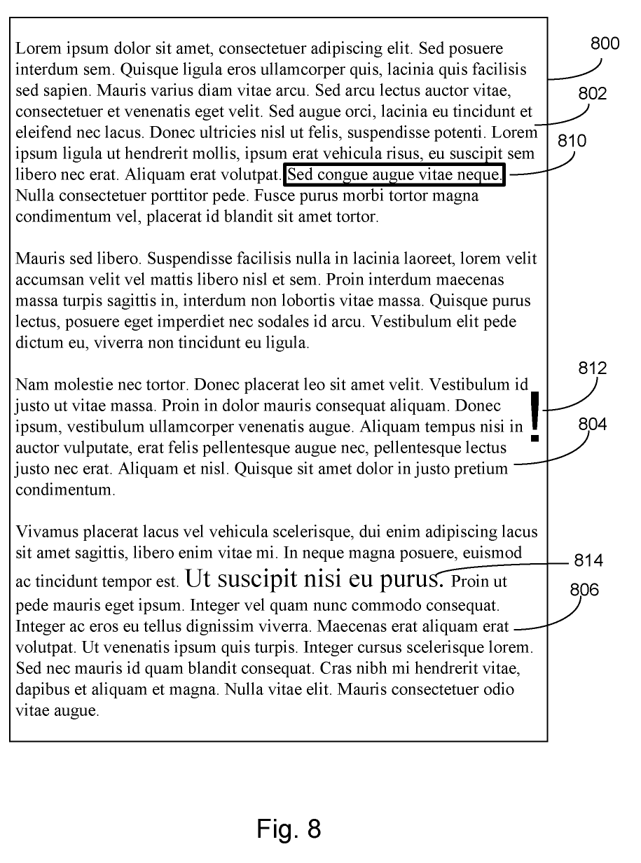

FIG. 8 shows an example of displaying search results in a word processing document 800 with associated attention information. The word processing document comprises different sections and paragraphs 802, 804 and 806. When the user has performed a search, the search has located this document as a result. The attention information collected earlier is then used to highlight passages 810, 812 and 814 in the document. This highlighting can happen in various ways, e.g. coloring or other highlighting options, with an icon or changing the size of the text.

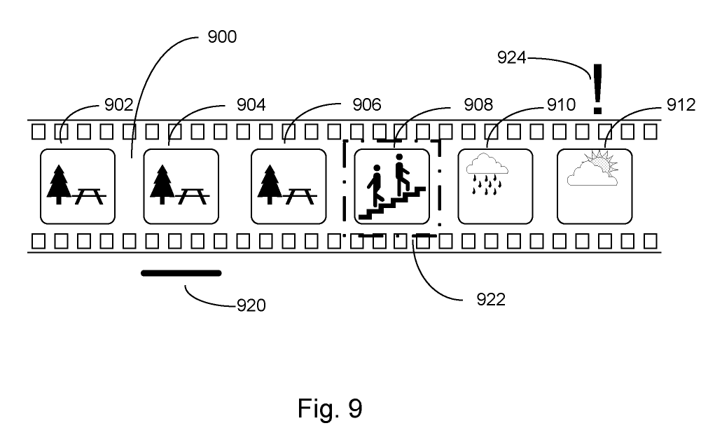

FIG. 9 shows an example of displaying search results in a multimedia file 900 with associated attention information. The multimedia file may be e.g. a movie or a video clip, or a music file. When the user has performed a search, the search has located this file as a result. The file contains different sections or scenes 902, 904, 906, 908, 910 and 912. The attention information collected earlier is then used to highlight scenes from the file with different highlighting options 920, 922 and 924. The scenes can be highlighted with bar like 920, an icon like 924 or by framing the scene as in 922.

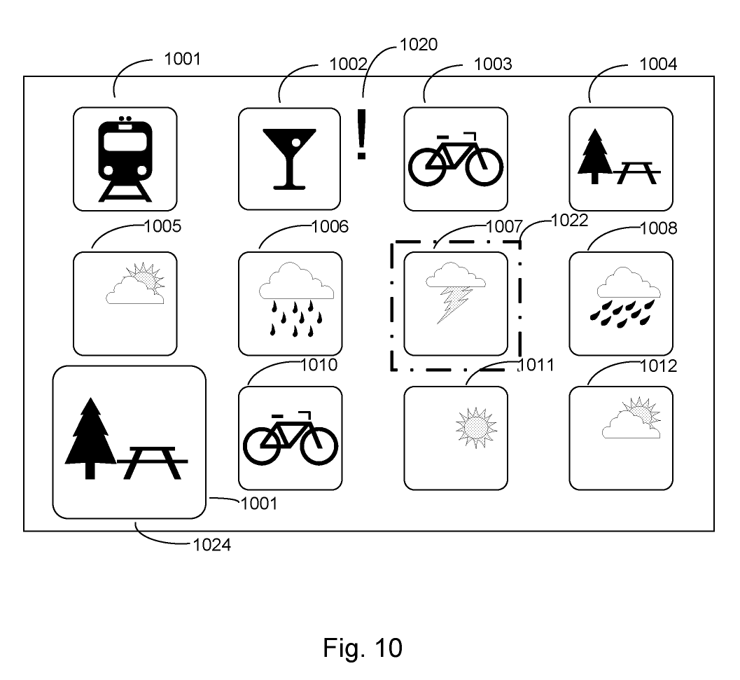

FIG. 10 shows an example of displaying search results among pictures with associated attention information. The pictures 1001-1012, e.g. photographs taken with a camera or a camera phone are displayed in a tiled setting on the screen. When the user has performed a search, the search has located these pictures as a result. Some of these pictures have associated attention information, and are highlighted with different highlighting options such as an icon 1020, a frame 1022 and enlarging the picture 1924. The pictures may also be displayed in an order according to the familiarity information.

The invention provides several advantages. New search criteria, i.e. the attention information can be used so that in addition to normal search criteria, the user can specify whether the data to be searched for is to be familiar, unfamiliar or slightly familiar. The use of attention information in searching also makes searching more convenient and personal since it utilizes knowledge on user behavior. The invention also provides the advantage that it is possible for a user to search for information that is familiar, slightly familiar or unfamiliar for another user or a group of users.

The various embodiments of the invention can be implemented with the help of computer program code that resides in a memory and causes the relevant apparatuses to carry out the invention. For example, a terminal device may comprise circuitry and electronics for handling, receiving and transmitting data, computer program code in a memory, and a processor that, when running the computer program code, causes the terminal device to carry out the features of an embodiment. Yet further, a network device may comprise circuitry and electronics for handling, receiving and transmitting data, computer program code in a memory, and a processor that, when running the computer program code, causes the network device to carry out the features of an embodiment.

It is obvious that the present invention is not limited solely to the above-presented embodiments, but it can be modified within the scope of the appended claims.

1. A method for searching information by an apparatus, comprising:
electronically generating a first search criterion based on input by a user, and
using said first search criterion for electronically carrying out a search from a first data set to electronically determine search results
electronically generating a second search criterion based on information on user attention, and
using said second search criterion in electronically determining said search results.

2-5. (canceled)

6. A method according to claim 1, further comprising:
receiving information containing said user input over a data connection, and
forming said first search criterion using said information containing said user input.

7-9. (canceled)

10. A method according to claim 1, further comprising:
forming said information on user attention by combining attention information associated with at least two users.

11-12. (canceled)

13. A method according to claim 1, further comprising:
forming advertisements to be displayed to the user, said advertisements being relevant to at least one of said search criteria and said search results.

14. An apparatus comprises at least one processor, memory including computer program code, the memory and the computer program code configured to, with the at least one processor, cause the apparatus to perform at least the following:
form a first search criterion based on input by a user, and
use said first search criterion for carrying out a search from a first data set to form search results
form a second search criterion based on information on user attention, and
use said second search criterion in forming said search results.

15. An apparatus according to claim 14, further comprises computer program code configured to, with the at least one processor, cause the apparatus to perform at least the following:
produce said search results to the user, and
indicate information of said user attention in connection with said search results to the user.

16. An apparatus according to claim 14, further comprises computer program code configured to, with the at least one processor, cause the apparatus to perform at least the following:
form said information on user attention by gaze tracking

17. An apparatus according to claim 14, further comprises computer program code configured to, with the at least one processor, cause the apparatus to perform at least the following:
form said information on user attention by measuring a physiological signal from a user.

18. An apparatus according to claim 14, further comprises computer program code configured to, with the at least one processor, cause the apparatus to perform at least the following:
receive said input by a user using at least one of the group of a keyboard, a mouse, a stylus, a touch sensitive screen or area, a speech detection system and an optical sensor such as a camera, a touch input, a voice input, or a brain wave based input, or any other sensor like a haptic sensor based on optics or impedance measurements.

19. An apparatus according to claim 14, further comprises computer program code configured to, with the at least one processor, cause the apparatus to perform at least the following:
receive information containing said user input over a data connection, and
form said first search criterion using said information containing said user input.

20. An apparatus according to claim 19, further comprises computer program code configured to, with the at least one processor, cause the apparatus to perform at least the following:
receive said information on user attention over a data connection, and
form said second search criterion using said information on user attention.

21. An apparatus according to claim 16, further comprises computer program code configured to, with the at least one processor, cause the apparatus to perform at least the following:
perform said gaze tracking using at least one of the group of eye orientation detection, face orientation detection and head orientation detection.

22. An apparatus according to claim 17, wherein said physiological signal is at least one of the group of an electroencephalograph, a magnetoencephalograph, a functional magnetic resonance image, an electrocardiograph, a magnetocardiograph and an electromyograph.

23. An apparatus according to claim 14, further comprises computer program code configured to, with the at least one processor, cause the apparatus to perform at least the following:
form said information on user attention by combining attention information associated with at least two users.

24. An apparatus according to claim 14, wherein said search relates to data containing textual information such as word processing information, presentation information and spreadsheet information.

25. An apparatus according to claim 14, wherein said search relates to data containing media information such as image information, video information, audio information and music information.

26. An apparatus according to claim 14, further comprises computer program code configured to, with the at least one processor, cause the apparatus to perform at least the following:
form advertisements to be displayed to the user, said advertisements being relevant to at least one of said search criteria and said search results.

27. An apparatus according to claim 14, the apparatus further comprises a sensor for attention tracking, user interface circuitry for receiving user input, user interface software configured to facilitate user control of at least some functions of the mobile phone through use of a display and configured to respond to user inputs, and a display and display circuitry configured to display at least a portion of a user interface of the mobile phone, the display and display circuitry configured to facilitate user control of at least some functions of the mobile phone, and computer program code configured to, with the at least one processor, cause the apparatus to perform at least the following:
track the attention of the user to form information on user attention
receive user input via the user interface circuitry to form the first search criterion
produce the search results via the display to the user.

28. A computer program product stored on a computer readable medium and executable in a data processing device, wherein the computer program product comprises
a computer program code section for forming a first search criterion based on input by a user, and
a computer program code section for using said first search criterion for carrying out a search from a first data set to form search results
a computer program code section for forming a second search criterion based on information on user attention, and
a computer program code section for using said second search criterion in forming said search results.

29. A computer program product according to claim 19, wherein the computer program product further comprises
a computer program code section for receiving information containing said user input over a data connection,
a computer program code section for forming said first search criterion using said information containing said user input,
a computer program code section for receiving said information on user attention over a data connection, and
a computer program code section for forming said second search criterion using said information on user attention.

30. (canceled)
